(19) United States
(12) Patent Application Publication
(10) Pub. No.: US 2007/0177789 A1
(43) Pub. Date: Aug. 2, 2007

(54) Solder paste inspection system and method

(76) Inventors: Jeffrey Harrell, Fort Collins, CO (US); James Mahon, Glasnevin (IE); Peter Conlon, Lucan (IE)

Correspondence Address: PERMAN & GREEN, 425 POST ROAD, FAIRFIELD, CT, 06824, US

(21) Appl. No.: 11/343,317

(22) Filed: Jan. 31, 2006

(51) Int. Cl. G06K 9/00

(52) U.S. Cl. 382/150

(57) ABSTRACT

A solder paste inspection machine carries out the steps of automatically generating inspection data for solder paste deposits, automatically determining a squeegee direction of travel for said paste deposits. It associates the squeegee direction with the inspection data, and feeds the inspection data back to a solder paste printer with an indication of squeegee direction. The direction is determined from three-dimensional range maps, the direction of squeegee travel being in the direction of upward slope.

The invention relates to solder paste inspection (“SPI”), particularly to manufacturing lines in which solder paste is screen printed.

Solder paste is screen printed onto printed circuit boards (PCB) in surface mount technology (SMT) manufacturing processes. During the printing process solder paste is pressed through a stencil by a squeegee onto the PCB. In order to achieve consistently high paste print quality the printer allows control of several variables, such as stencil XY offset, stencil orientation, squeegee level, squeegee pressure, and squeegee speed.

Typically modern paste printers have two squeegees; one which prints in the forward direction and one which prints in the reverse direction. For control purposes this essentially means that there are two separate paste printers in one machine.

The SMT line may include a solder paste inspection (SPI) machine. This machine inspects each deposit printed for XY offset, height, area and volume. This measurement data can be used to control the paste print process.

The invention is directed towards achieving improved control over screen printing quality.

### SUMMARY OF THE INVENTION

According to the invention, there is provided a solder paste inspection machine comprising a camera for capturing images of a substrate with printed solder paste, and an image processor for analysing the images to generate an indication of quality of the solder paste deposit operation, wherein a squeegee direction identification function automatically determines squeegee direction for paste deposits, and a feedback controller routes feedback to a paste machine, said feedback identifying the squeegee direction used for the deposits.

In one embodiment, the feedback controller separates feedback data into separate streams, one for each squeegee direction.

In one embodiment, the identification function automatically determines squeegee direction according to paste characteristics.

In another embodiment, the characteristics include solder deposit slope determined by said function from three-dimensional range maps, the direction of squeegee travel being in the direction of upward slope.

In one embodiment, the characteristics analyzed by said function include location of a plurality of adjacent paste deposits in a two-dimensional plane of the substrate with respect to target locations.

In one embodiment, the function treats a pattern of the deposits being consistently offset in one longitudinal direction as a characteristic.

In one embodiment, a pattern of alternate offsets for groups of deposits is a characteristic.

In one embodiment, the identification function recognises a mark applied by a printing machine to determine squeegee direction.

In another aspect, the invention provides a method of operation of a solder paste inspection machine comprising the steps of:
automatically generating inspection data for solder paste deposits,
automatically determining a squeegee direction of travel for said paste deposits, and
associating said squeegee direction with the inspection data, and feeding the inspection data back to a solder paste printer with an indication of squeegee direction.

In one embodiment, the inspection machine feeds back a separate stream of feedback data for each squeegee direction.

In a further embodiment, the inspection machine automatically determines squeegee print direction according to characteristics of the paste deposits.

In one embodiment of the method, the characteristics include solder deposit slope determined from three-dimensional range maps, the direction of squeegee travel being in the direction of upward slope.

### DETAILED DESCRIPTION OF THE INVENTION

The invention will be more clearly understood from the following description of some embodiments thereof, given by way of example only with reference to the accompanying drawings in which:

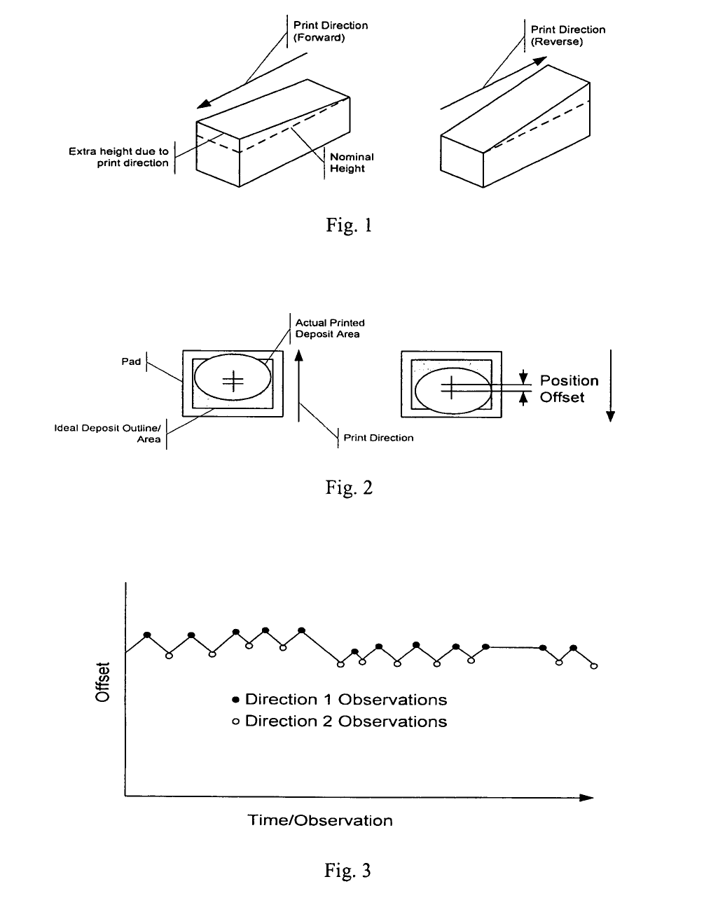

FIG. 1 is pair of diagrams giving perspective views to illustrate a characteristic which is identified by an inspection machine of the invention;

FIG. 2 is pair of plan views showing solder deposit characteristics of plan view images; and

FIG. 3 is a plot showing a pattern of observations indicative of squeegee direction.

This invention provides a method and system for associating squeegee direction with paste inspection data fed back. The measurements are separated according to squeegee direction, therefore allowing the correct print control parameters to be used. This allows closed loop (automatic or manual) control on any paste printer, the printer being able to directly associate the feedback data with a particular squeegee. The method does not require any input from the paste printer, although it is advantageous to have an indication of the starting direction in a board print sequence. The SPI machine can be placed at any position in the SMT line before re-flow as there is no need to perform solder paste inspection immediately after paste printing.

SPI measurement data is very advantageously separated into two streams: one for forward printing and one for reverse printing.

The stroke direction may be detected in different ways as follows:

Determining Stroke from 3D Data

FIG. 1 depicts a paste deposit whose long axis is parallel to the direction of travel of the printer squeegee. It is a general characteristic of the printing process that deposits will slope upwards in the direction of squeegee movement, as illustrated in these diagrams (the scale being exaggerated).

An SPI system of the invention creates 3D range maps of deposits from which the slight slope of the deposit can be determined. The system observes that on average, for a number of deposits on the board, that the slope of the deposits is generally in one direction, and so the squeegee print direction can be inferred. Upon doing so, the SPI system allocates feedback data for the printing machine into a correct stream.

Determining Stroke from 2D Data

Referring to FIG. 2, in another embodiment it is possible to determine if more than one squeegee stroke exists from the analysis of 2D paste deposit offset data. As shown in these diagrams the deposit area as viewed in 2D plan is offset in one direction or the other with respect to a target area. Although offset in general can arise for other reasons such as lateral displacement of the screen, the SPI system differentiates on the basis of the pattern of offsets. A series of alternate offsets in different directions indicates squeegee stroke direction rather than screen displacement.

If the offset data is analyzed a characteristic “zig-zag” can be observed, as shown in

FIG. 3. This characteristic includes a flat portion, indicating that a board has been removed.

Using a 2D inspection machine in conjunction with a data analysis tool it is possible to generate 2 separate offset data streams, one for either print direction. It is advantageous if the user indicates the starting print direction so that data streams can be assigned to an individual print direction.

In the case where long periods between inspections is observed the sequence of squeegee print direction may have changed (due perhaps to a cleaning cycle on the paste printer). For this situation the user may have to re-establish the starting print direction, or this can be automatically determined according to the characteristics illustrated in FIG. 2.

Squeegee Direction Notification

The screen printer may indicate the screen print direction by making a readable mark on all boards of one print direction. In this way, it would be very simple for the SPI system to aggregate data by stroke direction. This technique would not require barcodes or electronic communication between machines, although these are options.

Feedback of Measurement Data

Once print direction has been determined by any of the above methods measurement data is fed back to the paste printer, either automatically or manually. When feeding back print offset data (for the whole board), offsets may be made with reference to the centre of rotation of the stencil in the paste printer which will not be the same as the centre of mass of the deposits as inspected by the SPI machine.

The invention is not limited to the embodiments described but may be varied in construction and detail.

1. A solder paste inspection machine comprising a camera for capturing images of a substrate with printed solder paste, and an image processor for analysing the images to generate an indication of quality of the solder paste deposit operation, wherein a squeegee direction identification function automatically determines squeegee direction for paste deposits, and a feedback controller routes feedback to a paste machine, said feedback identifying the squeegee direction used for the deposits.

2. An inspection machine as claimed in claim 1, wherein the feedback controller separates feedback data into separate streams, one for each squeegee direction.

3. An inspection machine as claimed in claims 1, wherein the identification function automatically determines squeegee direction according to paste characteristics.

4. An inspection machine as claimed in claim 3, wherein the characteristics include solder deposit slope determined by said function from three-dimensional range maps, the direction of squeegee travel being in the direction of upward slope.

5. An inspection machine as claimed in claims 4, wherein the characteristics analyzed by said function include location of a plurality of adjacent paste deposits in a two-dimensional plane of the substrate with respect to target locations.

6. An inspection machine as claimed in claim 5, wherein the function treats a pattern of the deposits being consistently offset in one longitudinal direction as a characteristic.

7. An inspection machine as claimed in claim 6, wherein a pattern of alternate offsets for groups of deposits is a characteristic.

8. An inspection machine as claimed in claim 1, wherein the identification function recognises a mark applied by a printing machine to determine squeegee direction.

9. A method of operation of a solder paste inspection machine comprising the steps of:
automatically generating inspection data for solder paste deposits, automatically determining a squeegee direction of travel for said paste deposits, and associating said squeegee direction with the inspection data, and feeding the inspection data back to a solder paste printer with an indication of squeegee direction.

10. A method as claimed in claim 9, wherein the inspection machine feeds back a separate stream of feedback data for each squeegee direction.

11. A method as claimed in claims 9, wherein the inspection machine automatically determines squeegee print direction according to characteristics of the paste deposits.

12. A method as claimed in claim 11, wherein the characteristics include solder deposit slope determined from three-dimensional range maps, the direction of squeegee travel being in the direction of upward slope.
